(19) United States
(12) Patent Application Publication
(10) Pub. No.: US 2014/0072274 A1
(43) Pub. Date: Mar. 13, 2014

(54) COMPUTER-READABLE STORAGE MEDIUM HAVING INFORMATION PROCESSING PROGRAM STORED THEREIN, INFORMATION PROCESSING APPARATUS, INFORMATION PROCESSING SYSTEM, AND INFORMATION PROCESSING METHOD

(71) Applicant: NINTENDO CO., LTD., Kyoto (JP)

(72) Inventors: Masahiro NITTA, Kyoto (JP); Keizo OHTA, Kyoto (JP)

(73) Assignee: NINTENDO CO., LTD., Kyoto (JP)

(21) Appl. No.: 13/724,639

(22) Filed: Dec. 21, 2012

(30) Foreign Application Priority Data
Sep. 7, 2012 (JP) 2012-197320

(51) Int. Cl. H04N 9/87

(52) U.S. Cl. CPC H04N 9/87
USPC 386/230

(57) ABSTRACT

In an example imaging apparatus including a display section, an attitude of the imaging apparatus at a time of image taking is stored so as to be associated with the taken image. In reproducing the taken image on the display section, the taken image is displayed on the basis of the attitude at the time of image taking and a current attitude of the imaging apparatus.

### CROSS REFERENCE TO RELATED APPLICATION

The disclosure of Japanese Patent Application No. 2012-197320, filed on Sep. 7, 2012, is incorporated herein by reference.

### FIELD

The exemplary embodiments disclosed herein relate to a computer-readable storage medium having an information processing program stored therein, an information processing apparatus, an information processing system, and an information processing method, and more specifically, relate to a computer-readable storage medium having an information processing program stored therein, an information processing apparatus, an information processing system, and an information processing method which display an image taken by a camera.

### BACKGROUND AND SUMMARY

Conventionally, an electronic camera including a liquid crystal display unit has been known. In such an electronic camera, when shooting, an image/video of an object to be shot can be displayed on a display screen, and after shooting, the taken image can be reproduced and displayed on the display screen.

In the above electronic camera, even when a taken image is reproduced and displayed on the display screen, it is difficult to recognize the situation at the time when the image is taken, for example, spatial sensation of the place where the image is taken.

Therefore, an object of the exemplary embodiments is to provide a computer-readable storage medium having an information processing program stored therein, an information processing apparatus, an information processing system, and an information processing method which, when an image taken by an imaging apparatus is reproduced, can also provide to a user spatial sensation or the like of a place where the image is taken.

In order to attain the object described above, the following configurations are exemplified.

A configuration example is an computer-readable storage medium having stored therein an information processing program executed by a computer of an information processing apparatus including a display section and an attitude data output section configured to output attitude data corresponding to an attitude of the information processing apparatus. The information processing program causes the computer to operate as: a data acquisition section and a displaying section. The data acquisition section is configured to acquire predetermined taken image data and attitude data, at a time of image taking, of a predetermined imaging apparatus having performed image taking for the taken image data. The displaying section is configured to output, on the basis of the attitude data at the time of image taking that is acquired by the data acquisition section and attitude data indicating a current attitude of the information processing apparatus, a taken image based on taken image data associated with the attitude data to the display section.

According to the above configuration example, the user is allowed to recognize spatial sensation, at the time of image taking, of the image taken by the predetermined imaging apparatus.

In another configuration example, the information processing apparatus may include an imaging section configured to take an image to obtain the taken image data, and the information processing program may further cause the computer to operate as a storing section configured to store, in a predetermined storage section, the taken image data and attitude data of the information processing apparatus at a time when the image of the taken image data is taken, such that the taken image data and the attitude data are associated with each other. The data acquisition section may acquire, from the attitude data output section, the attitude data of the information processing apparatus at the time when the image is taken by the imaging section.

According to the above configuration example, since a taken image is displayed on the basis of the attitude of the information processing apparatus including the imaging section, the user is allowed to recognize spatial sensation of the image at the time of image taking

In another configuration example, the displaying section may output the taken image associated with the attitude data at the time of image taking to the display section according to a degree of sameness between current attitude data of the imaging apparatus and the attitude data at the time of image taking. In addition, the displaying section may display the taken image in a display range corresponding to the degree of the sameness.

According to the above configuration example, since the taken image is displayed according to the degree of the sameness between the current attitude of the imaging apparatus and the attitude at the time of image taking, the user is allowed to further recognize spatial sensation at the time of image taking.

In another configuration example, the displaying section may output, to the display section, a taken image associated with the attitude data at the time of image taking that coincides with or is close to the current attitude data of the imaging apparatus.

According to the above configuration example, for displaying a certain image, the attitude is adjusted to the attitude at the time when the image is taken. Thus, the user is allowed to easily recognize spatial sensation at the time when the image is taken.

In another configuration example, the storing section may be capable of storing a plurality of items of taken image data and attitude data in the storage section, and when there are a plurality of items of taken image data for which attitude data at times of image taking is close to each other, the displaying section may output taken images based on these items of taken image data to the display section such that the taken images arc displayed so as to overlap each other.

According to the above configuration example, for example, when a plurality of images of the same place or scene are taken, these images are displayed so as to overlap each other. Thus, the screen size of the display section can be effectively used.

In another configuration example, the storing section may store a date and time when the image is taken by the imaging section, as imaging date/time data in the storage section such that the imaging date/time data is associated with the taken image data, and when there are a plurality of taken images for which attitude data at times of image taking is close to each other, the displaying section may output there taken images such that a taken image for which associated imaging date and time are recent is displayed so as to be superimposed on a taken image for which associated imaging date and time are old.

According to the above configuration example, an image taken last is displayed, and the user's convenience can be improved.

In another configuration example, the displaying section may simultaneously output an image based on taken image data stored by the storing section and video acquired from the imaging section to the display section. Furthermore, the displaying section may simultaneously output the image and the video to the display section such that the image and the video arc distinguishable from each other. Here, the “video” is intended to be real-time video or substantially real-time video (video that is slightly temporally shifted but can be considered as being substantially in real time, not technically in real time) acquired from the imaging section.

According to the above configuration example, when the user desires to take an image of the same place as a place whose image is previously taken, the user is allowed to easily adjust the imaging position (imaging direction), and the user's convenience can be improved.

In another configuration example, the displaying section may output the video to the display section such that the video is superimposed on the image based on the taken image data.

According to the above configuration example, it is made easy to adjust the imaging position, and the user's convenience can be improved.

In another configuration example, the information processing program may further cause the computer to operate as an image processor configured to subject the taken image based on the taken image data to predetermined processing, and the displaying section may simultaneously output the taken image processed by the image processor and the video to the display section.

According to the above configuration example, when current video and a previously taken image are displayed on the display section, the user is allowed to easily distinguish between both images, and the user's convenience can be improved.

In another configuration example, the image processor may perform processing of decreasing a brightness of the taken image.

According to the above configuration example, the user is allowed to easily distinguish between current video and a previously taken image.

In another configuration example, the image processor may perform processing of increasing transparency of the taken image.

According to the above configuration example, the user is allowed to easily distinguish between current video and a previously taken image.

In another configuration example, the information processing program may further cause the computer to operate as a virtual space constructor configured to arrange an image based on the taken image data within a virtual space at a position based on the attitude data at the time of image taking, and the displaying section may output an image of the virtual space taken by a virtual camera to the display section.

According to the above configuration example, since a taken image arranged within the virtual space can be viewed by moving the imaging apparatus itself, the user is allowed to recognize the positional relation between imaged contents and spatial sensation of the place at the time of image taking with higher realism.

In another configuration example, the displaying section may control an attitude of the virtual camera on the basis of the current attitude of the imaging apparatus and outputs an image of the virtual space on the basis of the attitude of the virtual camera.

According to the above configuration example, since a taken image arranged within the virtual space can be viewed by moving the imaging apparatus itself, the user is allowed to recognize the positional relation between imaged contents and spatial sensation of the place at the time of image taking with higher realism.

In another configuration example, the virtual space constructor may determine an arranged position of the taken image within the virtual space on the basis of an angle of view at the time of image taking. Alternatively, the virtual space constructor may determine a size of the taken image within the virtual space on the basis of an angle of view at the time of image taking.

According to the above configuration example, the user is allowed to easily recognize spatial sensation at the time of image taking.

In another configuration example, the attitude data may be angular velocity data outputted from a predetermined angular velocity sensor.

According to the above configuration example, the attitude of the imaging apparatus can be recognized with a simple configuration using, for example, a gyro-sensor or the like.

According to the embodiments, when a taken image is reproduced and displayed, user experience that cannot be obtained merely when a plane image is reproduced, such as a spatial situation, sensation, and atmosphere of a place where the image is taken, can be provided.

These and other objects, features, aspects and advantages of the present invention will become more apparent from the following detailed description of non-limiting example embodiments when taken in conjunction with the accompanying drawings.

### BRIEF DESCRIPTION OF THE DRAWINGS

FIG. 1 is a block diagram showing an example of the configuration of an imaging apparatus 10;

FIG. 2 is a schematic diagram showing an outline of processing of an embodiment;

FIG. 3 is a diagram for explaining the outline of processing of the embodiment;

FIG. 4 is a diagram for explaining the outline of processing of the embodiment;

FIG. 5 is a diagram for explaining the outline of processing of the embodiment;

FIG. 6 is a diagram for explaining the outline of processing of the embodiment;

FIG. 7 is a diagram for explaining the outline of processing of the embodiment;

FIG. 8 is a diagram for explaining the outline of processing of the embodiment;

FIG. 9 is a diagram for explaining the outline of processing of the embodiment;

FIG. 10 is a diagram for explaining the outline of processing of the embodiment;

FIG. 11 is a diagram for explaining the outline of processing of the embodiment;

FIG. 12 is a diagram for explaining the outline of processing of the embodiment;

FIG. 13 is a diagram for explaining the outline of processing of the embodiment;

FIG. 14 is a diagram for explaining the outline of processing of the embodiment;

FIG. 15 is a diagram for explaining the outline of processing of the embodiment;

FIG. 16 is a diagram showing an example of a program and information stored in a main memory;

FIG. 17 is a flowchart showing an example of processing executed by a processor or the like; and

FIG. 18 is a flowchart showing the example of the processing executed by the processor or the like.

### DETAILED DESCRIPTION OF NON-LIMITING EXAMPLE EMBODIMENTS

Hereinafter, an embodiment will be described.

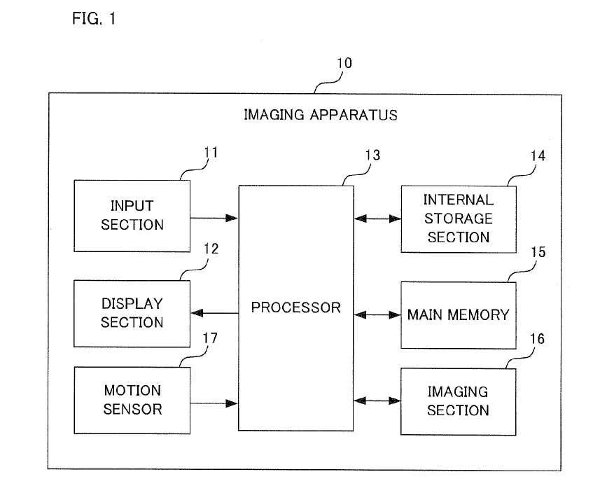

In FIG. 1, an imaging apparatus 10 includes an input section 11, a display section 12, a processor 13, an internal storage section 14, a main memory 15, an imaging section 16, and a motion sensor 17. It is noted that examples of the imaging apparatus 10 include a digital camera equipped with a motion sensor, and a mobile phone, a smart phone, a tablet terminal which are equipped with a motion sensor. In addition, a hand-held game apparatus or the like including a camera function and a motion sensor also corresponds to the imaging apparatus 10. In the present embodiment, a hand-held game apparatus including a camera function and a motion sensor will be described as an example of the imaging apparatus.

The input section 11 is operated by the user of the imaging apparatus 10 and outputs a signal corresponding to the operation of the user. The input section 11 is, for example, across switch, a push button, or a touch panel. The display section 12 displays, on a screen thereof, an image generated in the imaging apparatus 10. The display section 12 is typically a liquid crystal display device. In the internal storage section 14, computer programs to be executed by the processor 13 have been stored. The internal storage section 14 is typically a flash EEPROM. It is noted that an attachable/detachable storage medium (e.g., a memory card) may be used instead of the internal storage section 14. The main memory 15 temporarily stores computer programs and information. The imaging section 16 includes an image pickup element having predetermined resolution (e.g., a CCD image sensor, a CMOS image sensor, etc.) and a lens. The lens may have a zooming mechanism. The motion sensor 17 is a sensor for detecting a motion of the imaging apparatus 10 itself. In the present embodiment, the motion sensor 17 includes an acceleration sensor and an angular velocity sensor. The acceleration sensor detects magnitudes of accelerations (linear accelerations) in the directions of straight lines along three axial (xyz axial) directions, respectively. In addition, the angular velocity sensor detects angular velocities about the three axes (an x axis, a y axis, and a z axis). For example, the angular velocity sensor is a gyro-sensor and is composed of one chip of a three-axis gyro-sensor. The angular velocity sensor detects an angular velocity (per unit time) with respect to a yaw angle (an angular velocity about the y axis), an angular velocity (per unit time) with respect to a roll angle (an angular velocity about the z axis), and an angular velocity (per unit time) with respect to a pitch angle (an angular velocity about the x axis).

It is noted that other than the acceleration sensor and the angular velocity sensor, the motion sensor 17 may be another motion sensor such as a velocity sensor, a displacement sensor, or a rotation angle sensor. Alternatively, a magnetic sensor or an image sensor may be used, or any sensor that is capable of detecting an imaging direction and a tilt of the imaging apparatus 10 may be used.

Next, an operation outline of information processing executed by the imaging apparatus 10 according to the present embodiment will be described. The information processing is realized, for example, by execution of imaging application processing in the hand-held game apparatus which is an example of the imaging apparatus 10.

In the present embodiment, an image taken by the user using the imaging section 16 is stored together with data indicating an imaging direction and a tilt (i.e., attitude) of the imaging apparatus 10 at the time when the image is taken. The taken image stored thus can be viewed by the user by being displayed (reproduced) on the display section 12. In the present embodiment, in displaying taken images on the display section 12, display processing is performed using an attitude of the imaging apparatus 10 at the time when each image is taken. Specifically, in the case where the user desires to view a certain taken image, processing is executed in which the image is displayed on the display section 12 by adjusting the attitude of the imaging apparatus 10 to the attitude at the time when the image is taken.

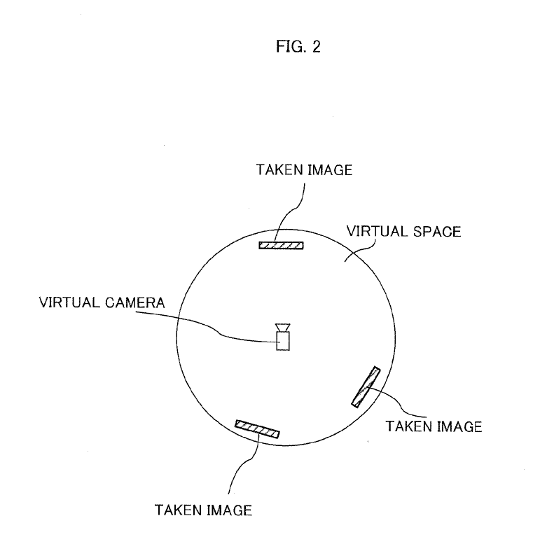

FIG. 2 is a schematic diagram showing a concept of processing of the present embodiment. In the present embodiment, a spherical virtual three-dimensional space (hereinafter, referred to merely as virtual space) having a predetermined size is used in execution of the imaging application processing. FIG. 2 shows a bird's-eye view of the virtual space. In the present embodiment, a virtual camera is located at the center of the virtual space. The virtual camera corresponds to the imaging apparatus 10, and the attitude of the virtual camera changes according to change in the attitude of the imaging apparatus 10. When an imaging operation is performed on the imaging apparatus 10, a taken image is arranged within the virtual space. At this arrangement, the taken image is arranged at a position within the virtual space corresponding to the attitude of the imaging apparatus 10 at the time when the image is taken (e.g., a position within the virtual space away from the virtual camera by a given distance). When viewing the image, the attitude of the virtual camera within the virtual space is changed by moving (changing the attitude of) the imaging apparatus 10 itself, and an image of the virtual space taken by the virtual camera is displayed on the display section 12. As a result, when the attitude of the imaging apparatus 10 is adjusted to the attitude at the time when each image is taken (the direction of the imaging apparatus is changed), the taken image corresponding to the attitude is displayed on the display section 12. Thus, by viewing, with the display section 12 of the imaging apparatus 10, the image taken by the imaging apparatus 10 including the display section 12 (integrated with the display section 12), the user is allowed to recognize spatial sensation of the place where the image is taken (e.g., a positional relation in a three-dimensional space of each image at the time when the image is taken).

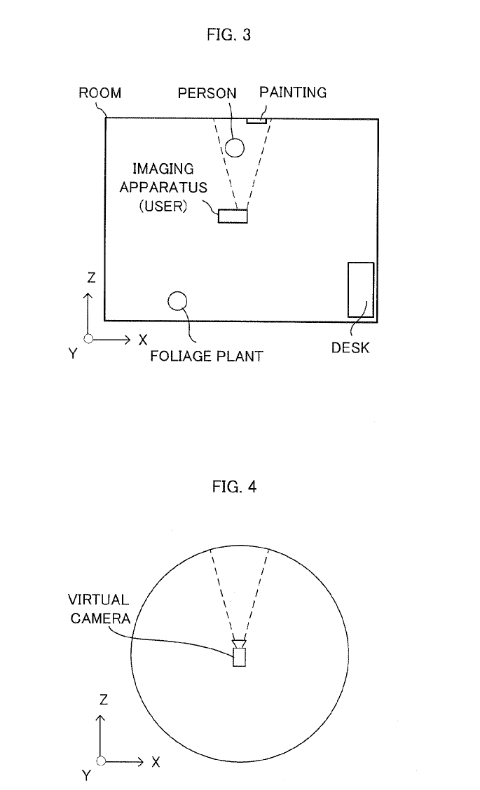

Next, an example of an operation assumed in the present embodiment will be described with reference to FIGS. 3 to 15. First, (an imaging application executed by) the imaging apparatus 10 according to the present embodiment has two operation modes, an “imaging mode” and a “reproduction mode”. These two modes are switchable by an operation of the user. The “imaging mode” is a mode mainly for taking an image using the imaging section 16. The “reproduction mode” is a mode mainly for viewing the taken image.

First, an operation in the “imaging mode” will be described. Here, a case is assumed where an image is taken in a situation as shown in FIG. 3. FIG. 3 is a schematic diagram showing a positional relation between (the user holding) the imaging apparatus 10 in the real space and a room in which the user is present. It is noted that FIG. 3 is a bird's eye view, and in the state of FIG. 3, when seen from the user, the front (depth) direction is defined as a Z-axis positive direction, the rightward direction is defined as an X-axis positive direction, and the upward direction is defined as a Y-axis positive direction. In addition, a person, a painting (on a wall), a desk, and a foliage plant are present in the room. In addition, FIG. 4 is a schematic diagram showing the direction of the virtual camera within the virtual space corresponding to the state of FIG. 3.

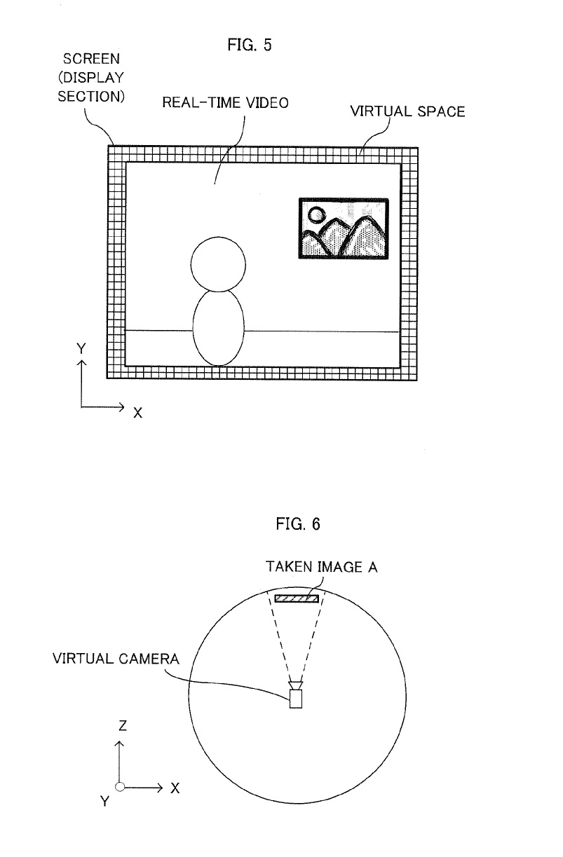

In the state of FIG. 3, a case is assumed where the user takes an image of the person. In this case, an image shown in FIG. 5 is displayed on the display section 12 of the imaging apparatus 10. In other words, real-time (camera) video (in which the person and the painting are shown) captured by the imaging section 16 is displayed on a major part of the screen, and the virtual space is displayed in the background. In other words, an image of the virtual space taken by the virtual camera is displayed on the display section 12, and the real-time video captured by the imaging section 16 is displayed so as to be superimposed on the image. It is noted that the virtual space serves as a background when a taken image or real-time video is displayed on the display section 12, and thus its design, used colors, and the like are preferably simple. In the present embodiment, a case is exemplified where a wall in the virtual space is designed to have squares as in a graph sheet.

In a state where the image shown in FIG. 5 is displayed on the display section 12, an imaging operation is performed by the user operating a predetermined shutter button. As a result, real-time video at that time is stored as a taken image in the main memory 15. Furthermore, together with the data of the taken image, data indicating the attitude of the imaging apparatus 10 (the attitude of the virtual camera) at that time is also stored in the main memory 15. The stored taken image is arranged within the virtual space. Specifically, a polygon (hereinafter, referred to as image polygon) having a predetermined size is arranged at a position within the virtual space as shown in FIG. 6 (hereinafter, a taken image A). This position is a position corresponding to the attitude (direction) of the imaging apparatus 10 at the time when the image is taken. More specifically, this position is a position located in the facing direction of the imaging apparatus 10 at the time when the image is taken. Here, in the present embodiment, the distance from the virtual camera to the arranged position is a predetermined distance. In addition, in the present embodiment, an angle of view (viewing angle) is set to a fixed value. The dimension (the size in the X-axis and Y-axis directions) of the image polygon is calculated according to the angle of view, and the taken image is attached. In another embodiment, the size of the image polygon may be previously set to predetermined fixed values, and the distance to the arranged position may be calculated according to the angle of view which is the fixed value. In still another embodiment, before entering the “imaging mode”, the angle of view may be settable, for example, by an operation of the user on a predetermined setting screen. In this case, the angle of view may not be able to be changed during the “imaging mode”. In still another embodiment, the angle of view may be changeable even during the “imaging mode”. Data indicating an angle of view at the time when the image is taken may be stored together with the data indicating the attitude and may be used for determining the size of the image polygon or the distance from the virtual camera to the arranged position.

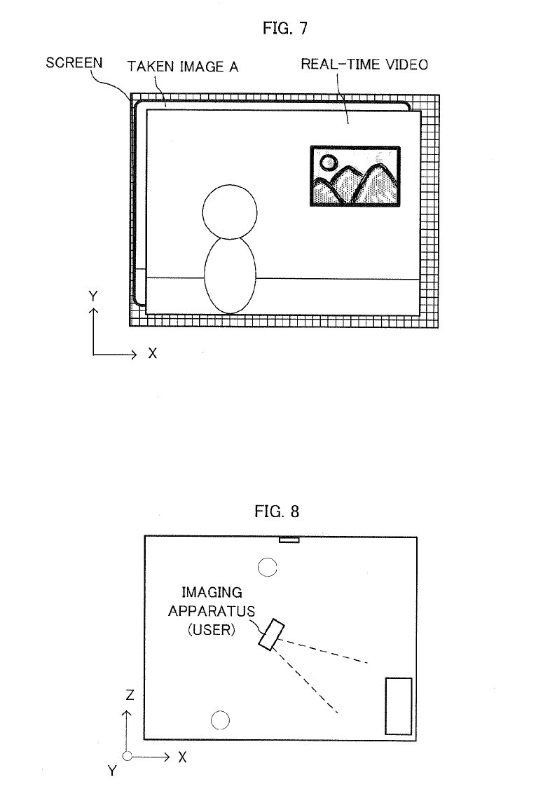

As a result of the image polygon being arranged as described above, an image in which real-time video is superimposed on the taken image (image polygon) is displayed on the display section 12 immediately after the image is taken. For example, an image shown in FIG. 7 is displayed. It is noted that for easily understanding the illustration, FIG. 7 shows a case where the attitude of the imaging apparatus 10 is changed slightly from the attitude at the time when the image is taken. In other words, FIG. 7 shows a state where the taken image and the real-time video superimposed thereon are displayed so as to be slightly shifted from each other.

As described above, in the “imaging mode,” the real-time video is displayed on the display section 12 so as to be superimposed on the taken image. However, the taken image may be subjected to predetermined processing and then displayed. For example, the transparency of the taken image may be increased (e.g., the taken image may be made translucent), and then the taken image may be displayed. Alternatively, the brightness of the taken image may be decreased, and then the taken image may be displayed (i.e., a duskish display may be provided). When the taken image is processed and displayed as described above, it is easy to distinguish the taken image from the real-time video. Thus, for example, in the case where an image of the same place is taken, “position adjustment” of a position where the image is taken (the attitude of the imaging apparatus) can easily be performed with reference to a previously taken image. Thus, processing performed on the taken image is not limited to the processing described above, and may be any processing that makes it easy to distinguish between the real-time video and the taken image and allows the position adjustment to be easily performed. For example, regarding the processing on the image, in addition to the setting of the transparency and the adjustment of the brightness as described above, processing of surrounding the taken image by a “frame” may be performed, and processing of causing the taken image to be monochrome may be performed. In addition, with regard to the image to be processed, not the taken image, but the real-time video may be processed. As an example of the processing, the real-time video may be processed so as to be translucently displayed and may be superimposed on the taken image. Furthermore, the example where the real-time video is superimposed on the front of the taken image has been described above, but the order of superimposing these images may be opposite. For example, a taken image that has been processed so as to be translucent may be superimposed on the front of real-time video.

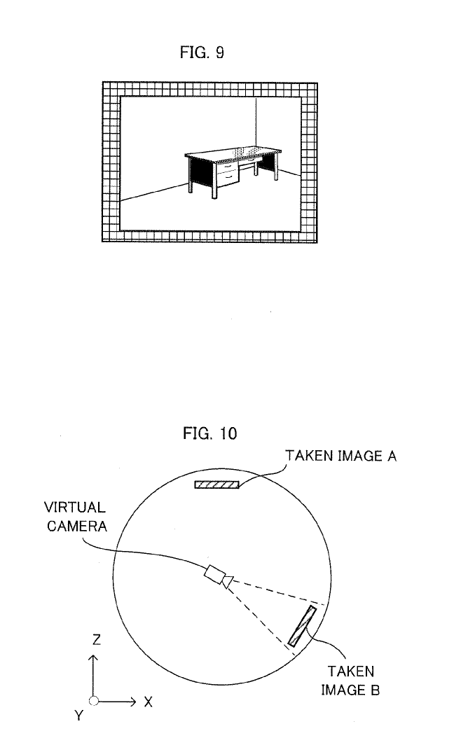

Next, a case is assumed where an image of the desk in the lower right of the room shown in FIG. 3 (the desk present in the diagonally backward right of the user in the state of FIG. 3) is taken. In this case, as shown in FIG. 8, the user (imaging apparatus 10) faces in the diagonally backward right direction from the state of FIG. 3 and takes an image. FIG. 9 shows an example of a display of the display section 12 at that time. When the user performs a shutter operation in this state, a second taken image is stored in the main memory 15 so as to be associated with the attitude of the imaging apparatus 10 (virtual camera) at that time, similarly as described above. Then, the taken image is arranged at a position within the virtual space corresponding to the attitude. FIG. 10 is a diagram showing a state within the virtual space in which the second taken image (hereinafter, referred to as taken image B) is arranged. At this time point, the two taken images (image polygons) are present within the virtual space. Their positional relation is also a relation generally corresponding to the positional relation between the person and the desk in the real space.

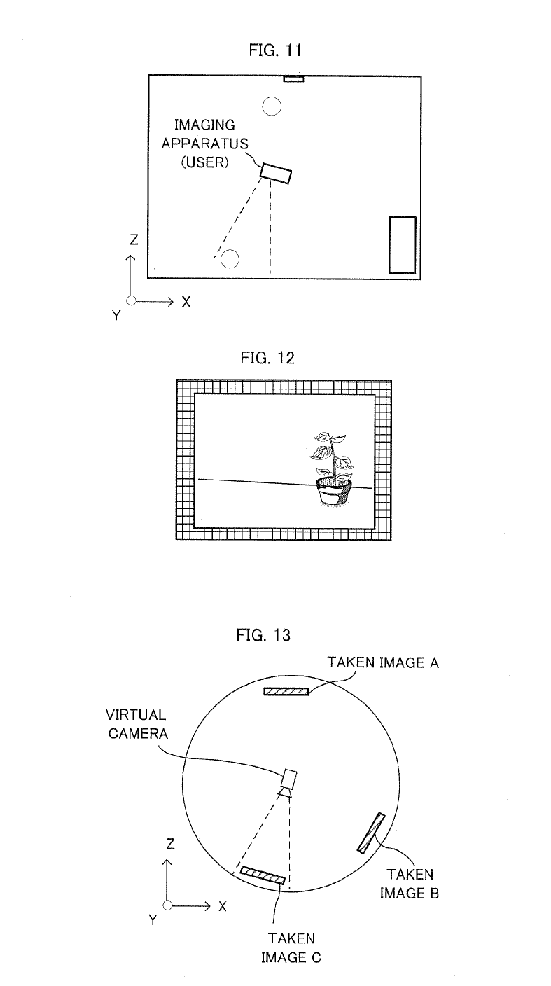

Furthermore, a case is assumed where an image of the foliage plant in FIG. 3 is taken as a third taken image. In this case, the imaging apparatus 10 (user) is directed as shown in FIG. 11. FIG. 12 shows an example of a display of the display section 12 at that time. When the user performs a shutter operation in this state, taken image data is stored so as to be associated with the attitude of the imaging apparatus at that time, similarly as described above, and the third taken image (hereinafter, referred to as taken image C) is arranged within the virtual space on the basis of the taken image data. As a result, the virtual space becomes a state where the three taken images (image polygons) are present as shown in FIG. 13.

In the case where a plurality of images of the same place are taken (in other words, in the case where the arranged positions of a plurality of taken images within the virtual space overlap each other), a plurality of image polygons are arranged such that the latest taken image is located in the front (on the virtual camera side).

The mage(s) taken through the operation as described above can be “saved” and stored per the “virtual space” described above (i.e., the virtual space is handled as one file). In addition, by “loading” the saved virtual space, the virtual space and the taken images included therein can be displayed on the display section 12. In another embodiment, taken images may be stored per image, not per virtual space (i.e., a set of an image and data indicating the attitude at the time when the image is taken is handled as one file).

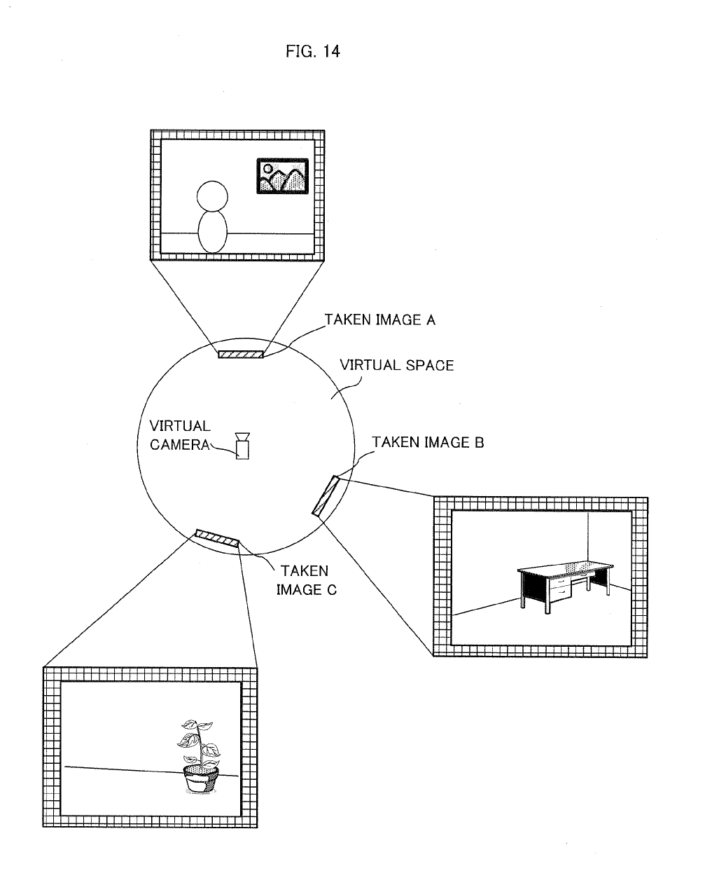

Next, an example of an operation in the “reproduction mode” will be described. Here, a case will be described where the three taken images A to C obtained as described above are viewed. The user performs a predetermined operation to load the data of the virtual space, and further switches the operation mode from the “imaging mode” to the “reproduction mode”. In the “reproduction mode”, an image of the virtual space taken by the virtual camera is displayed on the display section 12 (no real-time video is displayed). As a result of the imaging operation as described above, each taken image (image polygon) is arranged within the virtual space at a position corresponding to the attitude at the time when the image is taken, as shown in FIG. 14. By changing the direction of the imaging apparatus 10 itself, namely, by changing the attitude of the imaging apparatus 10, the user can change the attitude of the virtual camera within the virtual space. As a result, by changing the attitude of the imaging apparatus 10 to the attitude at the time when each image is taken, the attitude of the virtual camera is also changed, and the taken image corresponding to the attitude is displayed on the display section 12.

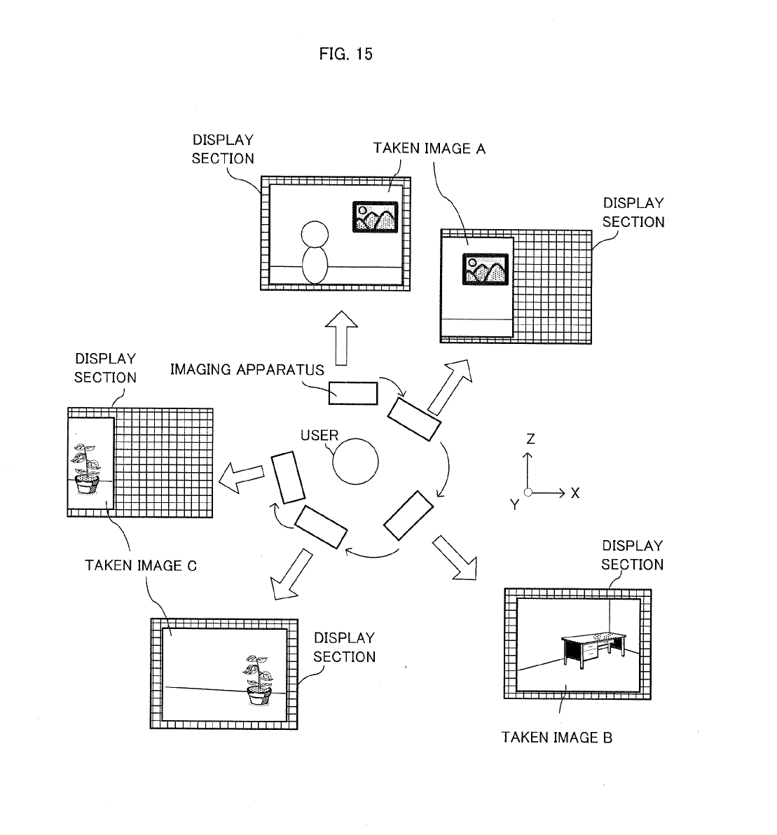

An example of the operation in the “reproduction mode” will be described with reference to FIG. 15. For example, a case is assumed where, in a place different from the room in which the images as described above are taken, the user views the three taken images using the “reproduction mode.” In this case, when the user directs the imaging apparatus 10 in a direction corresponding to the direction to the painting in FIG. 3, the taken image A is displayed on the display section 12. In addition, for example, when the imaging apparatus 10 itself is rotated slightly rightward from this attitude, a display is provided in which only a substantially right half of the taken image A is displayed on the display section 12. When the imaging apparatus 10 is rotated further rightward from this attitude, the taken image B is displayed on the display section 12. Then, when the imaging apparatus 10 is rotated further rightward as seen from the user, the taken image C appears on the display section 12. When the imaging apparatus 10 is rotated further rightward from this state, a state is provided where only a right-side portion of the taken image C is displayed. In other words, according to this, it can be said that a certain taken image is displayed on the display section 12 when the attitude of the imaging apparatus 10 coincides with the attitude at the time when the image is taken or when the attitude of the imaging apparatus 10 is close to the attitude at the time when the image is taken (in the above example, a state is provided where only a portion of the taken image is displayed). In addition, it can also be said that a taken image is displayed on the display section 12 according to the degree of sameness between the current attitude of the imaging apparatus 10 and the above attitude at the time when the image is taken. With regard to a certain taken image, the higher the degree of the sameness between the current attitude of the imaging apparatus 10 and the attitude at the time when the image is taken is (the closer to a state where the attitudes coincide with each other), the higher the proportion of the taken image displayed on the display section 12 is. In addition, when: the proportion of the taken image displayed on the display section 12 is decreased such that only a portion of the taken image is displayed as the degree of the sameness between the attitudes is decreased as described above; and, as a result, the degree of the sameness of the attitude becomes low such that both attitudes cannot be considered as being close to each other, a state is provided where the taken image is not displayed on the display section 12. As a method of displaying a taken image according to the degree of the sameness, other than changing the proportion of the region of the taken image displayed on the display section 12 as described above, for example, the size of the taken image may be changed according to the degree of the sameness in another embodiment. For example, it may be configured that the size of the taken image is decreased as the degree of the sameness is decreased, and when the attitudes coincide with each other, the taken image is displayed with a size that is substantially the same as the area size of the display section 12.

As described above, the taken image is stored so as to be associated with the attitude at the time when the image is taken, and in displaying the taken image on the display section 12, the taken image is displayed on the basis of the current attitude of the imaging apparatus and the attitude at the time when the image is taken. Thus, when the taken image is viewed, spatial sensation of the place where the image is taken can be provided to the user. For example, it is made easy to recognize the positional relation between objects shown in each of a plurality of taken images.

The attitude change by horizontal rotation (rotation movement on the XZ plane) has been exemplified in the above example. However, needless to say, even in the case of attitude change in the vertical direction (Y-axis direction) or in an oblique direction, similarly, a taken image is stored so as to be associated with an attitude and is displayed according to attitude.

Furthermore, the method in which the taken image is arranged in the virtual space has been described above as an example, but in another embodiment, it not necessarily necessary to use such a virtual space. Any processing may be performed as long as the processing is processing in which the attitude of the imaging apparatus 10 can be detected and a taken image is displayed on the display section 12 according to the attitude of the imaging apparatus at the time when the image is taken. For example, processing may be performed in which when the current attitude of the imaging apparatus 10 is compared to attitude data stored so as to be associated with each taken image and coincides with or is close to the attitude for a certain taken image, the image is read out and displayed on the display section 12.

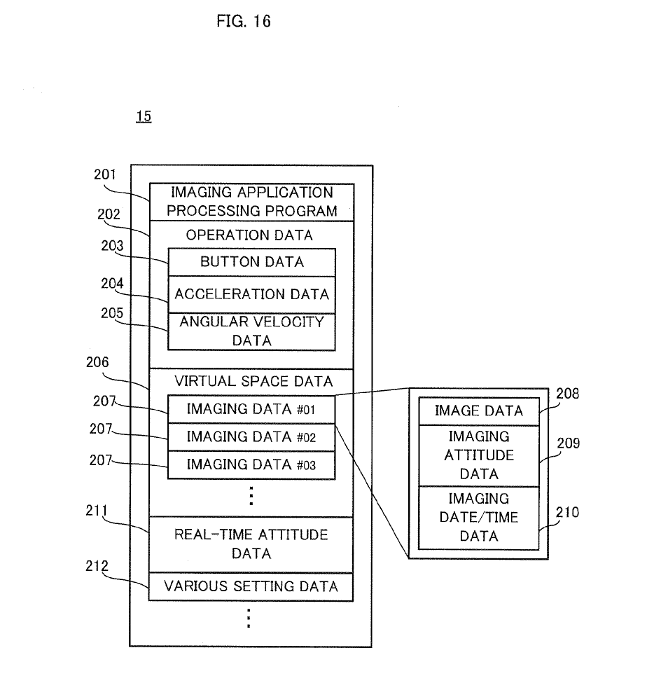

Next, an operation of the imaging apparatus 10 will be described in detail with reference to FIGS. 16 to 18.

FIG. 16 shows an example of a program and information stored in the main memory 15 of the imaging apparatus 10. In the main memory 15, an imaging application processing program 201, operation data 202, virtual space data 206, real-time attitude data 211, various setting data 212, and the like are stored.

The imaging application processing program 201 is a program for executing the “imaging mode” and the “reproduction mode” as described above.

The operation data 202 is data for indicating an operation of the user performed on the imaging apparatus 10. The operation data 202 includes button data 203, acceleration data 204, and angular velocity data 205.

The button data 203 is data indicating an input with respect to the input section 11 (operation buttons, a touch panel, and the like). For example, the button data 203 includes data indicating a state of touching the touch panel, a touch coordinate, and states of pressing various buttons. The acceleration data 204 is data indicating accelerations detected by the acceleration sensor included in the motion sensor 17. The angular velocity data 205 is data indicating angular velocities detected by the angular velocity sensor included in the motion sensor 17. Here, in the present embodiment, output from the motion sensor 17 is performed, for example, every 1/100 sec (every one-frame time for general game processing).

The virtual space data 206 is data for constituting the virtual space as described above. The virtual space data 206 includes one or more items of imaging data 207. Each imaging data 207 is composed of image data 208, imaging attitude data 209, and imaging date/time data 210. The image data 208 is data of a taken image. The imaging attitude data 209 is data indicating the attitude of the virtual camera (i.e., the attitude of the imaging apparatus 10) when the image is taken. The imaging attitude data 209 is, for example, data indicating three axial (xyz axial) vectors that represent the attitude of the virtual camera when the image is taken. The imaging date/time data 210 is data indicating the date and time when the image is taken.

In another embodiment, for example, in an embodiment in which the angle of view can be changed during the “imaging mode,” the imaging data 207 may include information indicating the angle of view at the time when the image is taken.

The real-time attitude data 211 is data indicating an attitude of the imaging apparatus 10 calculated on the basis of the angular velocity data 205. In addition, since the output from the motion sensor 17 is performed every 1/100 sec as described above, it is possible to calculate the attitude of the imaging apparatus 10 substantially in real time. Thus, the real-time attitude data 211 can be said to be data indicating a substantially real-time attitude of the imaging apparatus 10.

The various setting data 212 is data indicating various settings required for the processing according to the present embodiment. For example, data defining the sizes of the above image polygons is included.

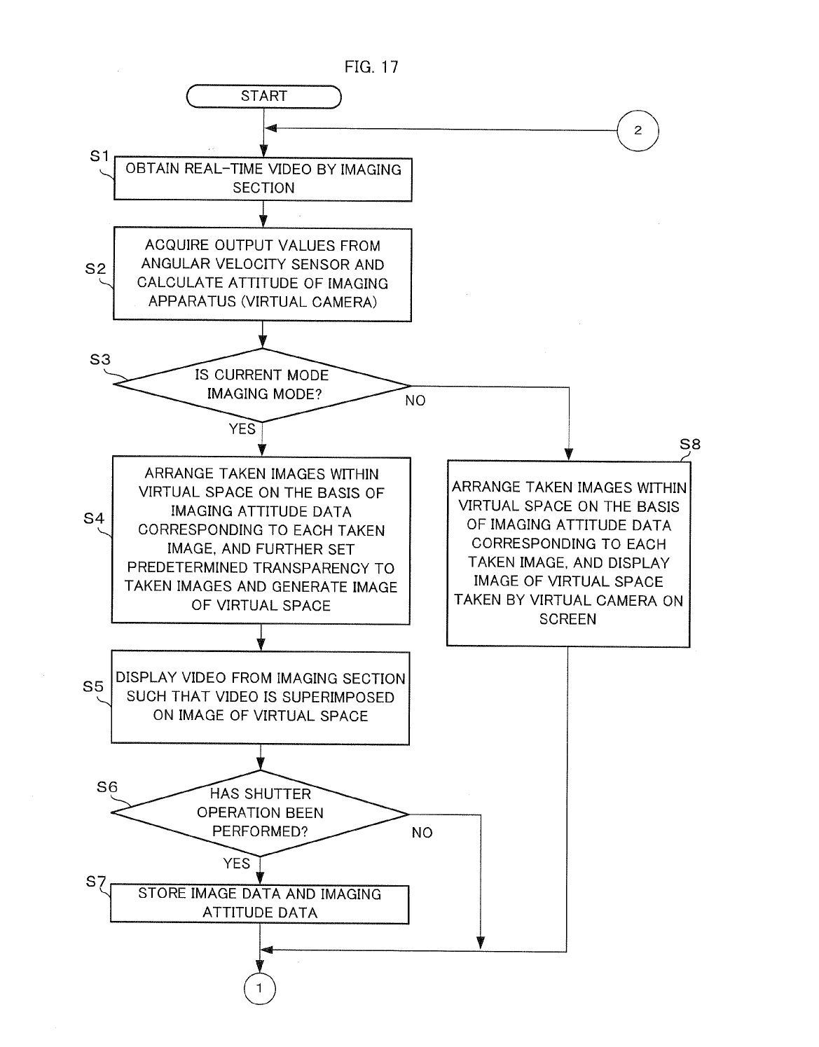

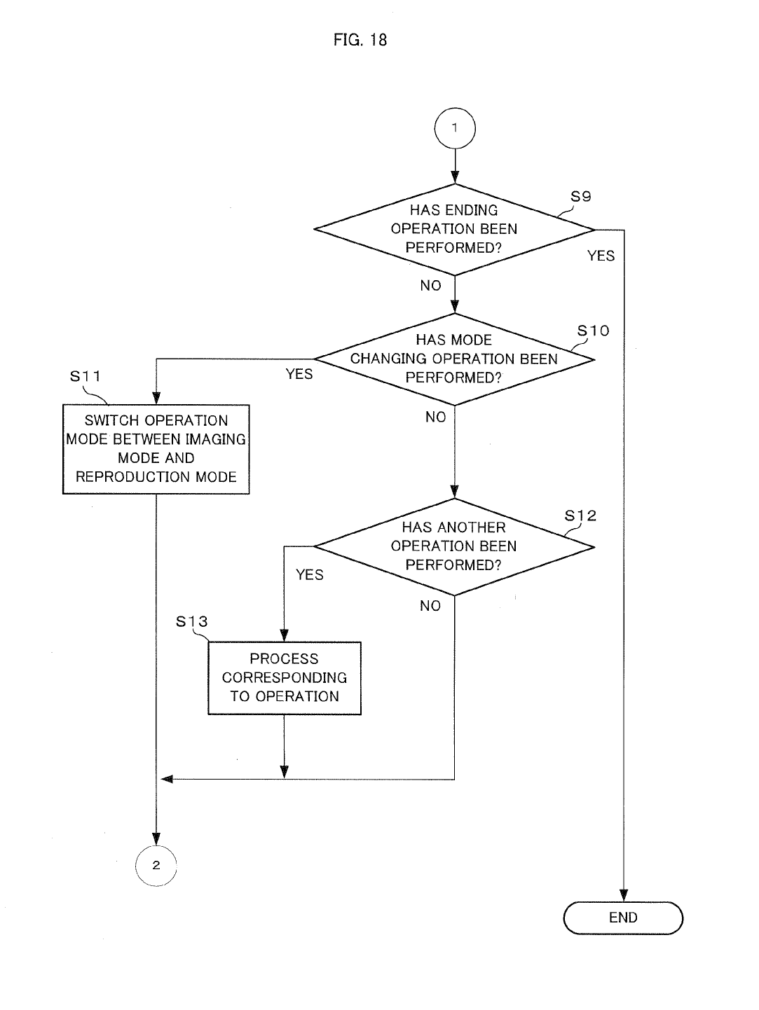

Next, flow of the imaging application processing executed by the processor 13 of the imaging apparatus 10 will be described with reference to flowcharts in FIGS. 17 and 18. It is noted that a default operation mode at start of the imaging application is set to the “imaging mode”.

When execution of the imaging application processing program 201 is started, a predetermined initialization process (not shown) is performed, and then the processor 13 obtains the above real-time video using the imaging section 16 at step S1.

Next, at step S2, the processor 13 acquires the angular velocity data 205 indicating the angular velocities detected by the angular velocity sensor of the motion sensor 17, calculates the attitude of the imaging apparatus 10 on the basis of the angular velocity data 205, and stores the calculated attitude as the real-time attitude data 211 in the main memory 15. Furthermore, the processor 13 sets the attitude indicated by the real-time attitude data 211, as the attitude of the virtual camera to set the attitude of the virtual camera as appropriate. In other words, the processor 13 reflects the current attitude of the imaging apparatus 10 in the attitude of the virtual camera.

Next, at step S3, the processor 13 determines whether or not the current operation mode is the “imaging mode”. As a result, when it is the “imaging mode” (YES at step S3), the processor 13 arranges images that have been taken at that time, within the virtual space at step S4. In other words, the processor 13 reads the imaging data 207 from the main memory 15 (or a predetermined storage medium such as a memory card), and determines an arranged position of a taken image corresponding to each imaging data 207 on the basis of the imaging attitude data 209 included in each imaging data 207. In addition, the processor 13 determines a tilt of each taken image on the basis of the attitude data (for example, when an image has been taken by the imaging apparatus 10 at such an attitude that the imaging apparatus 10 is tilted relative to the XY plane in FIG. 3, an image polygon is also tilted according to this attitude as appropriate). Then, the processor 13 arranges an image polygon to which the image based on the image data 208 is attached, at the position. At that time, the processor 13 sets the transparency of the image as appropriate such that the image is to be translucently displayed. Then, the processor 13 generates an image taken by the virtual camera. It is noted that when there is no taken image, the above image polygon arrangement is not performed, and thus an image of the virtual space in which no image polygon is present is taken. In addition, when there are a plurality of images taken at the same position (i.e., when there arc a plurality of taken images of the same place), the images are sorted on the basis of the imaging date/time data 210 such that the image whose imaging date and time are the most recent is located on the front side (the virtual camera side), and are arranged so as to overlap each other.

Next, at step S5, the processor 13 displays the real-time video obtained at step S1, on the display section 12 such that the real-time video is superimposed on the image of the virtual space generated at step S4.

Next, at step S6, the processor 13 refers to the operation data 202 and determines whether or not a shutter operation has been performed. For example, the process 13 determines whether or not a predetermined button assigned as a shutter button has been pressed. As a result of the determination, when the shutter operation has not been performed (NO at step S6), the processing proceeds to later-described step S9. On the other hand, when the shutter operation has been performed (YES at step S6), the processor 13 stores the real-time video at that time as the image data 208 in the main memory 15 and also stores the real-time attitude data 211 at that time as the imaging attitude data 209 in the main memory 15 at step S7. Thus, the taken image and the attitude of the imaging apparatus 10 (virtual camera) at the time when the image is taken are stored so as to be associated with each other. Furthermore, the processor 13 stores the date and time when the image is taken, as the imaging date/time data 210. Then, the processing proceeds to later-described step S9.

On the other hand, as a result of the determination at step S3, when the operation mode is not the “imaging mode” (NO at step S3), the operation mode is the “reproduction mode”. In this case, at step S8, the processor 13 arranges each taken image within the virtual space at a position based on the imaging attitude data 209 corresponding to each image. Then, the processing proceeds to later-described step S9.

Next, at step S9, the processor 13 refers to the operation data 202 and determines whether an operation for ending the imaging application processing has been performed. As a result, when the ending operation has been performed (YES at step S9), the processor 13 ends the imaging application processing. On the other hand, when the ending operation has not been performed (NO at step S9), the processor 13 refers to the operation data 202 and determines whether or not an operation for changing the operation mode has been performed, at step S10. As a result, when the operation for changing the operation mode has been performed (YES at step S10), the processor 13 performs a process of switching the operation mode at step S11. In other words, the processor 13 switches the operation mode to the “reproduction mode” when the imaging application has run in the “imaging mode”, and switches the operation mode to the “imaging mode” when the imaging application has run in the “reproduction mode.”

On the other hand, when the operation for changing the operation mode has not been performed (NO at step S10), the processor 13 refers to the operation data 202 and determines whether a certain operation other than the above operations has been performed, at step S12. When a certain operation has been performed (YES at step S12), the processor 13 executes a process corresponding to the operation as appropriate. For example, when a “save” operation for storing a taken image (the virtual space) has been performed, a process of storing the virtual space data 206 within the main memory 15 at that time, in a predetermined storage medium such as a memory card, is performed. Or, when a “load” operation has been performed, a process of loading the virtual space data 206 from saved data designated by the user and storing the virtual space data 206 in the main memory 15 is performed.

In the present embodiment, the following operation is also possible as another operation. For example, during the “reproduction mode”, a “zoom” operation (digital zoom) of a taken image is possible. In this case, predetermined buttons are assigned to “zoom in” and “zoom out”, and the processor 13 determines whether these buttons have been operated. According to the result, for example, the viewing angle of the virtual camera is changed to zoom in or out the taken image. In this manner, a digital zoom process is executed.

In addition, an operation of manually adjusting the imaging direction of the virtual camera in the right-left direction in the “imaging mode” is also possible as another operation. This operation is an operation performed in view of a point that there is nature that errors are accumulated with time in the case of the attitude calculation based on angular velocity. In other words, in the present embodiment, the attitude of the imaging apparatus 10 (virtual camera) is calculated on the basis of the output of the angular velocity sensor, but the output of the angular velocity sensor may include errors. Thus, for example, when rotational movement in the right-left direction is continuously made, the errors are accumulated. As a result, the facing direction of the imaging apparatus 10 (the imaging direction of the virtual camera) calculated by the processor 13 on the basis of the angular velocity data 205 may “shift” from the direction in which the imaging apparatus 10 actually faces (the actual attitude of the imaging apparatus 10). Accordingly, during the “imaging mode”, even when the imaging apparatus is directed in the same direction at the same place, real-time video displayed on the display section 12 and an image taken previously at the same place may be displayed so as to be shifted from each other. Thus, it may be configured that the user is allowed to manually change the attitude of the virtual camera in the right-left direction when the user notices the above “shift” during the “imaging mode.” Specifically, fine adjustment may be able to be performed by using a cross key of the input section 11. For example, when the user presses a right-direction portion of the cross key, a process is performed in which, for example, the virtual camera is rotated rightward by a predetermined angle or a predetermined offset value is set and applied. In other words, the processor 13 executes such a process as to rotate the virtual camera in the right-left direction according to an operation of the user.

It is noted that the above manually adjusting operation is not necessarily necessary for the up-down direction. This is because the direction of gravitational acceleration can be calculated on the basis of the output of the acceleration sensor, and thus it is possible to automatically compensate for a “shift” in the up-down direction on the basis of the gravitational acceleration (for example, step S2, such compensation based on gravitational acceleration suffices to he performed). As a matter of course, the direction of the virtual camera may be able to be manually adjusted in the up-down direction.

As described above, in the present embodiment, in the imaging apparatus including the display section, each taken image is stored together with the attitude of the imaging apparatus at the time when the image is taken. In displaying the image on the display section, the image is displayed when the attitude of the imaging apparatus itself is changed to the attitude at the time when each image is taken. Thus, when the user views a taken image, three-dimensional spatial sensation at the time when the image is taken can be provided to the user.

In the above example, when there are a plurality of taken images of the same place, these images are sorted in chronological order from the image having the latest imaging date and time, and are arranged within the virtual space so as to overlap each other. Thus, the user can always see the latest taken image. At that time, the image displayed in the foreground may be able to be changed to an image having the oldest imaging date and time by the user performing a predetermined operation.

In addition, in the above embodiment, the example has been described where the attitude of the virtual camera is changed according to change in the attitude of the imaging apparatus 10. However, the above embodiment is not limited thereto, and unlike the above, the attitude of the virtual camera may be fixed, and the virtual space itself may be rotated according to change in the attitude of the imaging apparatus 10.

In addition, other than the imaging apparatus described above, a part of the processing described in the above embodiment is also applicable to an information processing apparatus that does not have an imaging function and includes a motion sensor and a display section. Specifically, the “reproduction mode” is also applicable to such an information processing apparatus. For example, the “reproduction mode” is applicable to a case where data of images taken by the above imaging apparatus is stored in a storage medium such as a memory card and is reproduced on another information processing apparatus.

In addition, in the above embodiment, a series of processes concerning the imaging application processing is performed in a single apparatus (the imaging apparatus 10). In another embodiment, the series of processes may be performed in an information processing system that includes a plurality of information processing apparatuses. For example, in an information processing system that includes an imaging apparatus and a server side apparatus communicable with the imaging apparatus via a network, a part of the series of processes may be performed by the server side apparatus. Alternatively, in an information processing system that includes an imaging apparatus and a server side apparatus communicable with the imaging apparatus via a network, a main process of the series of the processes may be performed by the server side apparatus, and a part of the series of the processes may be performed by the imaging apparatus. Still alternatively, in the information processing system, a server side system may include a plurality of information processing apparatuses, and a process to be performed in the server side system may be divided and performed by the plurality of information processing apparatuses.

What is claimed is:

1. A computer-readable storage medium having stored therein an information processing program executed by a computer of an information processing apparatus including a display section and an attitude data output section configured to output attitude data corresponding to an attitude of the information processing apparatus, the information processing program causing the computer to operate as:
a data acquisition section configured to acquire predetermined taken image data and attitude data, at a time of image taking, of a predetermined imaging apparatus having performed image taking for the taken image data; and
a displaying section configured to output, on the basis of the attitude data at the time of image taking that is acquired by the data acquisition section and attitude data indicating a current attitude of the information processing apparatus, a taken image based on taken image data associated with the attitude data to the display section.

2. The computer-readable storage medium according to claim 1, wherein
the information processing apparatus includes an imaging section configured to take an image to obtain the taken image data,
the information processing program further causes the computer to operate as a storing section configured to store, in a predetermined storage section, the taken image data and attitude data of the information processing apparatus at a time when the image of the taken image data is taken, such that the taken image data and the attitude data are associated with each other, and
the data acquisition section acquires, from the attitude data output section, the attitude data of the information processing apparatus at the time when the image is taken by the imaging section.

3. The computer-readable storage medium according to claim 1, wherein the displaying section outputs the taken image associated with the attitude data at the time of image taking to the display section according to a degree of sameness between current attitude data of the imaging apparatus and the attitude data at the time of image taking.

4. The computer-readable storage medium according to claim 3, wherein the displaying section displays the taken image in a display range corresponding to the degree of the sameness between the current attitude data of the imaging apparatus and the attitude data at the time of image taking.

5. The computer-readable storage medium according to claim 3, wherein the displaying section outputs, to the display section, a taken image associated with the attitude data at the time of image taking that coincides with or is close to the current attitude data of the imaging apparatus.

6. The computer-readable storage medium according to claim 2, wherein
the storing section is capable of storing a plurality of items of taken image data and attitude data in the storage section, and
when there are a plurality of items of taken image data for which attitude data at times of image taking is close to each other, the displaying section outputs taken images based on these items of taken image data to the display section such that the taken images are displayed so as to overlap each other.

7. The computer-readable storage medium according to claim 6, wherein
the storing section stores a date and time when the image is taken by the imaging section, as imaging date/time data in the storage section such that the imaging date/time data is associated with the taken image data, and
when there are a plurality of taken images for which attitude data at times of image taking is close to each other, the displaying section outputs there taken images such that a taken image for which associated imaging date and time are recent is displayed so as to be superimposed on a taken image for which associated imaging date and time arc old.

8. The computer-readable storage medium according to claim 2, wherein the displaying section simultaneously outputs an image based on taken image data stored by the storing section and video acquired from the imaging section to the display section.

9. The computer-readable storage medium according to claim 8, wherein the displaying section simultaneously outputs the image based on the taken image data stored by the storing section and the video acquired from the imaging section to the display section such that the image and the video are distinguishable from each other.

10. The computer-readable storage medium according to claim 9, wherein the displaying section outputs the video to the display section such that the video is superimposed on the image based on the taken image data.

11. The computer-readable storage medium according to claim 9, wherein
the information processing program further causes the computer to operate as an image processor configured to subject the taken image based on the taken image data to predetermined processing, and
the displaying section simultaneously outputs the taken image processed by the image processor and the video to the display section.

12. The computer-readable storage medium according to claim 11, wherein the image processor performs processing of decreasing a brightness of the taken image.

13. The computer-readable storage medium according to claim 11, wherein the image processor performs processing of increasing transparency of the taken image.

14. The computer-readable storage medium according to claim 1, wherein
the information processing program further causes the computer to operate as a virtual space constructor configured to arrange an image based on the taken image data within a virtual space at a position based on the attitude data at the time of image taking, and
the displaying section outputs an image of the virtual space taken by a virtual camera to the display section.

15. The computer-readable storage medium according to claim 14, wherein the displaying section controls an attitude of the virtual camera on the basis of the current attitude of the imaging apparatus and outputs an image of the virtual space on the basis of the attitude of the virtual camera.

16. The computer-readable storage medium according to claim 14, wherein the virtual space constructor determines an arranged position of the taken image within the virtual space on the basis of an angle of view at the time of image taking.

17. The computer-readable storage medium according to claim 14, wherein the virtual space constructor determines a size of the taken image within the virtual space on the basis of an angle of view at the time of image taking.

18. The computer-readable storage medium according to claim 1, wherein the attitude data is angular velocity data outputted from a predetermined angular velocity sensor.

19. An information processing apparatus including a display section and an attitude data output section configured to output attitude data corresponding to an attitude of the information processing apparatus, the information processing apparatus comprising:
a data acquisition section configured to acquire predetermined taken image data and attitude data, at a time of image taking, of a predetermined imaging apparatus having performed image taking for the taken image data; and
a displaying section configured to output, on the basis of the attitude data at the time of image taking that is acquired by the data acquisition section and attitude data indicating a current attitude of the information processing apparatus, a taken image based on taken image data associated with the attitude data to the display section.

20. An information processing system including a display section and an attitude data output section configured to output attitude data corresponding to an attitude of the information processing system, the information processing system comprising:
a data acquisition section configured to acquire predetermined taken image data and attitude data, at a time of image taking, of a predetermined imaging apparatus having performed image taking for the taken image data; and
a displaying section configured to output, on the basis of the attitude data at the time of image taking that is acquired by the data acquisition section and attitude data indicating a current attitude of the information processing system, a taken image based on taken image data associated with the attitude data to the display section.

21. An information processing method for controlling an information processing apparatus including a display section and an attitude data output section configured to output attitude data corresponding to an attitude of the information processing apparatus, the information processing method comprising the steps of:
acquiring predetermined taken image data and attitude data, at a time of image taking, of a predetermined imaging apparatus having performed image taking for the taken image data; and
outputting, on the basis of the attitude data at the time of image taking that is acquired at the acquiring step and attitude data indicating a current attitude of the information processing apparatus, a taken image based on taken image data associated with the attitude data to the display section.
